(19) United States
(12) Patent Application Publication
(10) Pub. No.: US 2026/0279837 A1
(43) Pub. Date: Sep. 17, 2026

(54) ELECTRODES FOR RECHARGEABLE LITHIUM BATTERIES AND RECHARGEABLE LITHIUM BATTERIES INCLUDING THE SAME

(71) Applicant: SAMSUNG SDI CO., LTD., Yongin-si (KR)

(72) Inventor: Dong Bok YANG, Yongin-si (KR)

(73) Assignee: SAMSUNG SDI CO., LTD., Yongin-si (KR)

(21) Appl. No.: 19/548,346

(22) Filed: Feb. 24, 2026

(30) Foreign Application Priority Data
Mar. 17, 2025 (KR) 10-2025-0034168

(51) Int. Cl. H01M 4/74; H01M 4/02; H01M 4/38; H01M 4/525; H01M 4/587; H01M 4/62; H01M 10/0525

(52) U.S. Cl. CPC H01M 4/74; H01M 2004/021; H01M 4/386; H01M 4/525; H01M 4/587; H01M 4/625; H01M 10/0525

(57) ABSTRACT

Disclosed are an electrode, and a rechargeable lithium battery including the electrode. The electrode includes an electrode current collector, an electrode active material layer on at least one surface of the electrode current collector, and a mesh layer located in the electrode active material layer and spaced apart from the electrode current collector.

### CROSS-REFERENCE TO RELATED APPLICATION

This application claims priority to and the benefit of Korean Patent Application No. 10-2025-0034168 filed with the Korean Intellectual Property Office on Mar. 17, 2025, the entire contents of which are incorporated herein by reference.

### BACKGROUND

### 1. Field

Electrodes, and rechargeable lithium batteries including the electrodes, are disclosed.

### 2. Description of the Related Art

Rechargeable lithium batteries, which are easy to carry as well as implement high energy density, are widely used as power sources for mobile information terminals such as, e.g., smart phones, laptops, and the like. Accordingly, obtaining rechargeable lithium batteries with high safety and high capacity for use as power sources for hybrid vehicles and electric vehicles, or for storing electric power, may be advantageous.

In order to achieve high capacity and high energy density, the capacity may be increased by coating the active material thickly. However, if (when) the active material is coated thickly, the electrochemical characteristics of the rechargeable battery may deteriorate, and cycle-life may deteriorate. Therefore, developing a high-capacity and high-energy density rechargeable battery that reduces or prevents deterioration of cycle-life without deteriorating the electrical characteristics of the rechargeable battery may be advantageous.

### SUMMARY

Some example embodiments include a high-capacity and high-energy-density electrode, and a rechargeable lithium battery including the high-energy-density electrode, which can improve electrical conductivity by shortening the movement path of electrons and ions within the electrode even when the active material is thickly coated by including a mesh layer between electrode active material layers.

In some example embodiments, an electrode includes an electrode current collector, an electrode active material layer on at least one surface of the electrode current collector, and a mesh layer located inside the electrode active material layer and spaced apart from the electrode current collector.

In some example embodiments, a rechargeable lithium battery includes a positive electrode, a negative electrode, and an electrolyte, wherein at least one of the positive electrode and the negative electrode is or includes the aforementioned electrode.

An electrode according to some example embodiments can provide a high-capacity and high-energy-density electrode that reduces or prevents cycle-life degradation by including a mesh layer between electrode active material layers to improve adhesive strength and enhance electrical conductivity, thereby enabling thick film coating.

### BRIEF DESCRIPTION OF THE DRAWINGS

FIG. 1 is a perspective view illustrating an electrode according to some example embodiments.

FIG. 2 is a cross-sectional view illustrating an electrode according to some example embodiments.

FIG. 3 is a cross-sectional view schematically illustrating a mesh layer according to some example embodiments.

FIG. 4, FIG. 5, FIG. 6, FIG. 7, FIG. 8 and FIG. 9 are drawings showing the alignment form of the mesh skeleton and the conductive material.

FIG. 10, FIG. 11, FIG. 12 and FIG. 13 are schematic views illustrating rechargeable lithium batteries according to some example embodiments.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

In the drawings, the thickness of layers, films, panels, regions, and the like, are exaggerated for clarity, and like reference numerals designate like elements throughout the specification. It is understood that when an element such as a layer, film, region, or substrate is referred to as being “on” another element, the element can be directly on the other element, or intervening elements may also be present there between. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring the average particle diameter using a dynamic light scattering method, performing data analysis, counting the number of particles for each particle size range, and calculating from this. Unless otherwise defined, the average particle diameter (D₅₀) may refer to the diameter of particles having a cumulative volume of 50 vol % in the particle size distribution. As used herein, when a definition is not otherwise provided, the average particle diameter (D₅₀) refers to a diameter of particles having a cumulative volume of 50 vol % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Electrode

In some example embodiments, an electrode includes an electrode current collector, an electrode active material layer on at least one surface of the electrode current collector, and a mesh layer located inside the electrode active material layer and spaced apart from the electrode current collector. The electrode may be an electrode of a rechargeable lithium battery.

In order to achieve high capacity and high energy density, a method of thickly coating and pressing an active material on the electrode current collector has been mainly used. However, this method may present a challenge of weakening bonding between electrode current collector and active material, and also slowing down a reaction speed due to a longer ion and electron transport path. As a result, electrical characteristics of the rechargeable battery may be deteriorated, and as charge and discharge are repeated, stability is deteriorated, leading to a challenge of reducing battery cycle-life.

Accordingly, in some example embodiments, the mesh layer is located between electrode active material layers to address the challenge. The mesh layer is not only disposed between active material layers, but also the electrode active material is filled in holes of the mesh layer, improving bonding between active materials, and thereby increasing structural stability of the electrode. In addition, the transfer path of electrons and ions within the electrode may be shortened, and increase electrical conductivity to improve the reaction speed, thereby making it possible to apply the active material to be thicker. This may not only achieve the high capacity and high energy density, but also effectively reduce or prevent the cycle-life degradation of the battery.

Conventionally, it is known to use an electrode current collector having a mesh structure. The current collector hawing a mesh structure typically has low Vickers hardness, which may lead to difficulties in adhesion when the active material is coated on the current collector surface. This problem may deteriorate uniformity and stability of the coating layer, and may thus negatively affect battery performance. In addition, if (when) the mesh layer is positioned not between active material layers but directly on the current collector, the active material is substantially difficult to coat to be thick due to a substantially low adhesive strength. Meanwhile, an example of the present disclosure locates the mesh layer inside the active material layer to achieve a thick coating as well as a stable coating and thereby improve the battery performance.

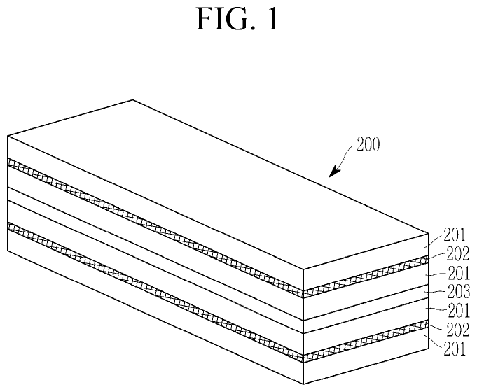

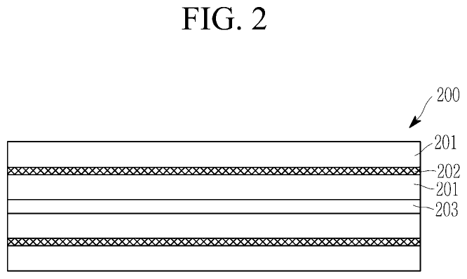

An electrode according to some example embodiments is described below with reference to FIG. 1 and FIG. 2. FIG. 1 is a perspective view illustrating an electrode according to some example embodiments, and FIG. 2 is a cross-sectional view illustrating an electrode according to some example embodiments. Referring to FIG. 1 and FIG. 2, the electrode 200 has an electrode active material layer 201 on both surfaces of the electrode current collector 203. For example, a mesh layer 202 is disposed between the electrode active material layers 201, and the mesh layer 202 is spaced apart from the electrode current collector 203 by an electrode active material layer 201.

The components that make up the electrode are described in detail below.

### Mesh Layer

In an electrode 200 according to some example embodiments, a mesh layer 202 is positioned between electrode active material layers 201 on an electrode current collector 203, and is positioned spaced apart from the electrode current collector 203. The mesh layer 202 may include a mesh skeleton. The mesh skeleton may include a metallic material, a carbon material, or a combination thereof. The metallic material may include at least one of copper, silver, iron, aluminum, or a combination thereof. The metallic material may generally provide desired or improved electrical conductivity, which can improve the movement path of electrons and ions within the electrode. The carbon material may include at least one of graphene, carbon nanotubes, graphite, carbon fibers, carbon black, or a combination thereof. The carbon material may provide electrochemical stability and high conductivity, which can facilitate the movement of ions and electrons within the electrode.

According to some example embodiments, the performance of the electrode may be improved or maximized by controlling the physical properties of the mesh layer 202. A pore size of the mesh layer 202 may be set to a range of about 0.01 μm to about 100 μm, about 10 μm to about 70 μm, about 0.01 μm to about 10 μm, about 20 μm to about 40 μm, about 20 μm to about 34 μm, about 30 μm to about 60 μm, or about 31 μm to about 54 μm to improve or optimize the movement path of ions and electrons within the electrode. If (when) the pore size is set as in the above range, effective ion and electron transfer between the active material and the mesh layer may be enabled, which can contribute to improving the reaction rate of the electrode and stably maintaining battery performance.

Additionally, the number of holes per unit area (in²) of the mesh layer 202 may be in a range of about 10 to about 100,000, or about 1,000 to about 10,000. Within the above range, each hole in the mesh layer is arranged in a certain pattern so that electrons and ions can move actively.

A diameter of the mesh skeleton may be in a range of about 0.01 μm to about 100 μm, about 0.1 μm to about 10 μm, about 0.1 μm to about 5 μm, about 0.1 μm to about 2 μm, or about 0.1 μm to about 1 μm. Within the above range, the mesh skeleton can form a uniform and robust conductive path throughout the electrode structure, while securing a balance between electrical conductivity, strength, and flexibility. Therefore, even when a thick active material layer is applied, rapid ion movement is possible through the mesh layer, which can contribute to improving battery cycle-life and performance.

A thickness of the mesh layer 202 may be in a range of about 1% to about 10%, about 2% to about 9%, or about 3% to about 8% relative to the total thickness of the electrode. Within the above range, the adhesive strength of the electrode may be strengthened and the electrical conductivity of the electrode may be increased.

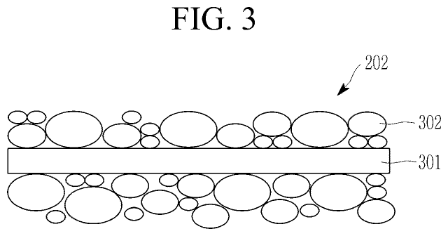

The mesh layer 202 may further include a conductive material to implement improved electrochemical characteristics. Such a mesh layer 202 of this structure is illustrated in FIG. 3. FIG. 3 is a cross-sectional view schematically illustrating a mesh layer 202 according to some example embodiments. The conductive material 302 may be coated and disposed on at least one surface of the mesh skeleton 301. The conductive material 302 may be coated on a single surface, or on both surfaces, as shown on the mesh skeleton 301 in FIG. 3. The conductive material 302 may include at least one of graphene, carbon nanotubes, graphite, carbon fiber, carbon black, or a combination thereof. The graphene and carbon nanotubes may provide desired or improved electrical conductivity and structural stability. The graphite, carbon fiber, and carbon black have desired or improved dispersibility and mechanical strength, allowing them to form a uniform and stable conductive network across the electrode.

A particle size of the conductive material 302 may be in a range of about 0.005 μm to about 50 μm, about 0.007 μm to about 0.020 μm, about 0.01 μm to about 1 μm, about 0.1 μm to about 5 μm, about 1 μm to about 10 μm, or about 10 μm to about 50 μm. Within the above range, the electrical conductivity is high, so that electron and ion movement may be activated. The particle shape of the conductive material 302 may be various shapes other than spherical or irregular, and the surface area and contact surface area may be controlled depending on the particle shape.

For example, the conductive material 302 may be included in an amount in a range of about 0 wt % to about 50 wt %, about 0.5 wt % to about 30 wt %, about 0.5 wt % to about 10 wt %, or about 0.5 wt % to about 5 wt % based on 100 wt % of the mesh layer. Within the above range, when the amount of the conductive material is low, the battery manufacturing process may be simplified and the cost may be reduced, and when the amount of the conductive material is high, the electrical conductivity may be improved or maximized, thereby improving the electrochemical characteristics of the rechargeable battery.

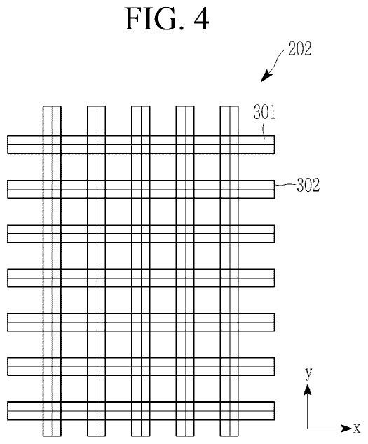

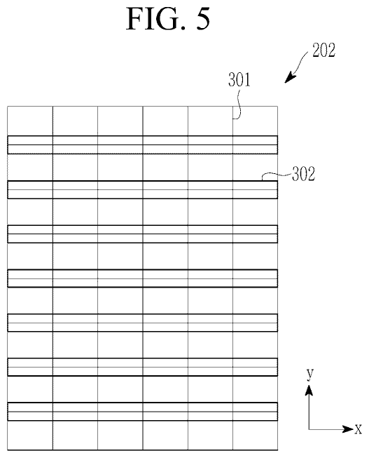

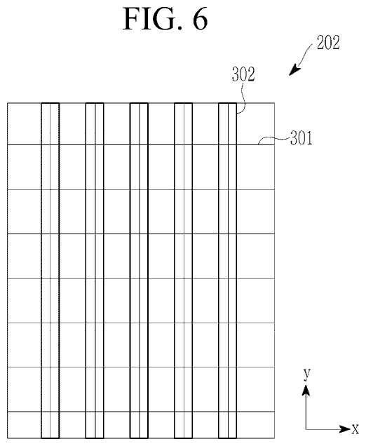

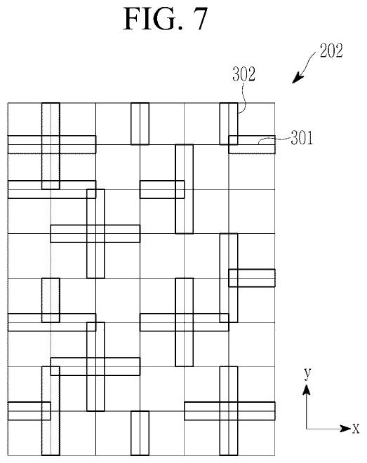

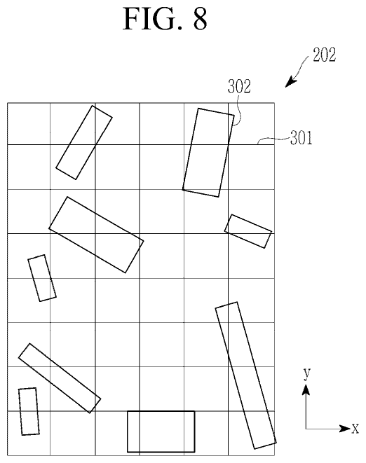

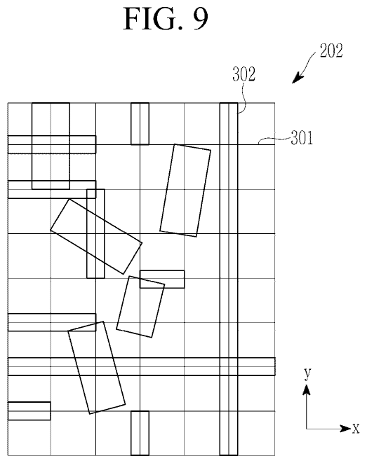

The conductive material 302 may be disposed and coated in various forms on the mesh skeleton. The alignment state of the conductive material for the mesh skeleton is shown in FIG. 4 to FIG. 9.

According to some example embodiments, the conductive material may be disposed in alignment in at least one direction of the x-axis or y-axis direction of the mesh skeleton. FIG. 4 to FIG. 7 show an alignment state in which a conductive material is aligned in at least one direction of the x-axis or y-axis direction of the mesh skeleton. Referring to FIG. 4, the conductive material 302 is aligned along the x-axis direction and y-axis direction of the mesh skeleton 301. Referring to FIG. 5, the conductive material 302 is aligned along the x-axis direction of the mesh skeleton 301. Referring to FIG. 6, the conductive material 302 is aligned along the y-axis direction of the mesh skeleton 301. Referring to FIG. 7, a conductive material 302 is disposed on a portion of the mesh skeleton 301 along the x-axis and the y-axis. If (when) the conductive material 302 is aligned on the mesh skeleton 301 as described above, the reaction speed and transfer efficiency can be improved or maximized by consistently forming electron and ion movement paths.

According to some example embodiments, the conductive material 302 may be irregularly distributed and disposed relative to the mesh skeleton 301. FIG. 8 shows an alignment state in which a conductive material 302 is irregularly distributed and disposed on a mesh skeleton 301. In this case, electrical conductivity may be achieved across the entire mesh layer, enabling stable performance to be achieved across the entire electrode.

According to some example embodiments, the conductive material 302 may be disposed in a mixed manner in the aligned shape and the irregularly distributed shape. FIG. 9 shows an alignment state in which aligned and irregularly distributed shapes of a conductive material 302 are mixed and disposed on a mesh skeleton 301. Through the hybrid arrangement, the electrodes may simultaneously or contemporaneously obtain high conductivity provided by the aligned structure and electrical conductivity distributed throughout the mesh layer provided by the irregular distribution.

### Electrode Current Collector

The electrode current collector is not particularly limited as long as the electrode current collector has conductivity without causing adverse chemical changes in the rechargeable lithium battery.

The electrode current collector may vary depending on the type of electrode. For example, when the electrode is a positive electrode, the electrode current collector may be or include a positive electrode current collector, for example, an aluminum (Al) thin film, and when the electrode is a negative electrode, the electrode current collector may be or include a negative electrode current collector, for example, a copper (Cu) thin film.

A thickness of the electrode current collector may be in a range of about 1% to about 10%, about 3% to about 10%, or about 3% to about 8% of the total thickness of the electrode. Within the above range, the weight and thickness of the electrode may be reduced or minimized.

### Electrode Active Material Layer

By including the mesh layer between the active material layers, a structure in the form of active material layer-mesh layer-active material layer may be formed. Each active material layer may include an electrode active material, and the electrode active material may vary depending on the type of electrode. For example, if (when) the electrode is a positive electrode, the electrode active material layer may be a positive electrode active material layer, and the electrode active material may be a positive electrode active material. If (when) the electrode is a negative electrode, the electrode active material layer may be a negative electrode active material layer, and the electrode active material may be a negative electrode active material.

A thickness of the electrode active material layer may be in a range of about 82% to about 98%, about 84% to about 95%, or about 86% to about 95% of the total thickness of the electrode. Within the above range, the electrode may improve or optimize energy density.

The positive electrode active material may be or include a compound (lithiated intercalation compound) capable of intercalating and deintercalating lithium. For example, one or more types of composite oxides of lithium and a metal such as or including at least one of cobalt, manganese, nickel, and combinations thereof may be used.

The composite oxide may be or include a lithium transition metal composite oxide, and the lithium transition metal composite oxide may be or include at least one of a lithium nickel-based composite oxide, a lithium cobalt-based composite oxide, a lithium manganese-based composite oxide, a lithium iron phosphate-based compound, a cobalt-free lithium nickel-manganese-based composite oxide, or a combination thereof.

As an example, a compound represented by any one of the following chemical formulas may be used. LiₐA_{1-b}X_{b}O_{2-c}D_{c} (0.90≤a≤1.8, 0≤b≥0.5, 0≤c≤0.05); LiₐMn_{2-b}X₆O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)} Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

More specifically, the positive electrode active material may include a lithium nickel-based composite oxide represented by Chemical Formula 1, a lithium cobalt-based composite oxide represented by Chemical Formula 2, or a combination thereof.

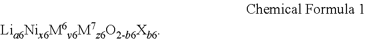

In Chemical Formula 1, 0.9≤a6≤1.8, 0.3≤x6≤1, 0≤y6≤0.7, 0≤z6≤0.7, 0.9≤x6+y6+z6≤1.1, and 0≤b6≤0.1, M⁶ and M⁷ each independently is or includes at least one of Al, B, Ba, Ca, Ce, Co, Cr, Cu, Fe, Mg, Mn, Mo, Nb, Si, Sn, Sr, Ti, V, W, Zr, or a combination thereof, and X is or includes at least one of F, P, S, or a combination thereof.

In Chemical Formula 1, 0.6≤x6≤1, 0≤y6≤0.4, and 0≤z6≤0.4, or 0.8≤x6≤1, 0≤y6≤0.2, and 0≤z6≤0.2 may be satisfied.

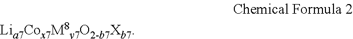

In Chemical Formula 2, 0.9≤a7≤1.8, 0.7≤x7≤1, 0≤y7≤0.3, 0.9≤x7+y7≤1.1, and 0≤b7≤0.1, M⁸ is or includes at least one of Al, B, Ba, Ca, Ce, Cr, Cu, Fe, Mg, Mn, Mo, Ni, Se, Si, Sn, Sr, Ti, V, W, Y, Zn, Zr, or a combination thereof, and X is or includes at least one of F, P, S, or a combination thereof.

In Chemical Formula 2, 0.8≤x7≤1, and 0≤y7≤0.2, or 0.7≤x7≤0.9, and 0≤y7≤0.2 may be satisfied.

For example, the positive electrode active material may be or include a high-nickel positive electrode active material in which the nickel content is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in a lithium transition metal composite oxide. The high-nickel positive electrode active materials may achieve high capacity, and may be applicable to high-capacity, high-density rechargeable lithium batteries.

As another example, the positive electrode active material may include a lithium cobalt-based composite oxide, in which case desired or improved capacity and cycle-life characteristics may be realized in a high voltage range.

An amount of the positive electrode active material may be in a range of about 60 wt % to about 99.9 wt %, about 70 wt % to about 99.8 wt %, about 80 wt % to about 99 wt %, about 90 wt % to about 99.8 wt %, or about 94 wt % to about 99 wt %, based on 100 wt % of the positive electrode active material layer.

The positive electrode active material layer may optionally further include a binder, a conductive material, or a combination thereof, together with the positive electrode active material.

The binder attaches the positive electrode active materials to each other, and also attaches the positive electrode active materials to the electrode current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity, and any electrically conductive material may be used as a conductive material unless the electrically conductive material causes an adverse chemical change in the battery. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

In the positive electrode active material layer, an amount of the binder may be in a range of about 0.1 wt % to about 5 wt %, or about 0.5 wt % to about 3 wt %, based on 100 wt % of the positive electrode active material layer, and the content of the conductive material may be in a range of about 0.1 wt % to about 5 wt %, or about 0.5 wt % to about 3 wt %, based on 100 wt % of the positive electrode active material layer.

For example, if (when) the electrode is a negative electrode, the electrode active material layer may be a negative electrode active material layer, and the electrode active material may be a negative electrode active material.

The negative electrode active material includes at least one of a material capable of reversibly intercalating/deintercalating lithium ions, lithium metal, an alloy of lithium metal, a material capable of doping and dedoping lithium, or a transition metal oxide.

The material capable of reversibly intercalating/deintercalating the lithium ions may be or include a carbon-based negative electrode active material.

The carbon-based negative electrode active material may include crystalline carbon, amorphous carbon, or a combination thereof. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like. The soft carbon refers to a carbon material that can be graphitized, and is a material that is readily graphitized by heat treatment at a high temperature, for example, about 2800° C. The hard carbon is a carbon material that cannot be graphitized, or is finely graphitized, by heat treatment.

The negative electrode active material layer may further include other types of negative electrode active materials in addition to the carbon-based negative electrode active material, and may further include, for example, at least one of a lithium metal, an alloy of lithium metal, a material capable of doping and dedoping lithium, and the like.

As the lithium metal alloy, an alloy of lithium and a metal such as or including at least one of Na, K, Rb, Cs, Fr, Be, Mg, Ca, Sr, Si, Sb, Pb, In, Zn, Ba, Ra, Ge, Al, Sn, or a combination thereof may be used.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to some example embodiments, the silicon-carbon composite may be in the form of silicon particles and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material or Sn-based negative electrode active material may be mixed with the carbon-based negative electrode active material.

The negative electrode active material layer may optionally further include a binder, a conductive material, or a combination thereof, together with the negative electrode active material.

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed together. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes an adverse chemical change in the battery. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

The negative electrode active material may be included in an amount in a range of about 90 wt % to about 99.8 wt %, or about 94 wt % to about 99 wt % based on 100 wt % of the negative electrode active material layer, the binder may be included in an amount in a range of about 0.1 wt % to about 5 wt %, or about 0.5 wt % to about 3 wt % based on 100 wt % of the negative electrode active material layer, and the conductive material may be included in an amount in a range of about 0.1 wt % to about 5 wt %, or about 0.5 wt % to about 3 wt % based on 100 wt % of the negative electrode active material layer.

### Rechargeable Lithium Battery

A rechargeable lithium battery according to some example embodiments includes a positive electrode, a negative electrode, and an electrolyte. At least one of the positive and negative electrodes is the aforementioned electrode. Either one of the positive electrode and the negative electrode may be the aforementioned electrode, or both the positive electrode and the negative electrode may be the aforementioned electrode.

When the positive electrode is the electrode described above, the positive electrode includes a positive electrode current collector, a positive electrode active material layer formed on at least one surface of the positive electrode current collector, and a mesh layer located inside the positive electrode active material layer and spaced apart from the positive electrode current collector. In addition, when the negative electrode is the electrode described above, the negative electrode includes a negative electrode current collector, a negative electrode active material layer formed on at least one surface of the negative electrode current collector, and a mesh layer located inside the negative electrode active material layer and spaced apart from the negative electrode current collector. Any duplicated content in the electrodes described above is omitted.

### Electrolyte

For example, the electrolyte for a rechargeable lithium battery may be an electrolyte solution, which may include a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, tert-butyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like. The aprotic solvent may include at least one of nitriles such as R-CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents.

When using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₂C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethane sulfonate, lithium difluorobis(oxalato)phosphate (LiDFBOP), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one surface, or on both surfaces, of the porous substrate.

The porous substrate may be or include a polymer film formed of or including any one polymer such as or including at least one of polyolefin such as at least one of polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (PTFE; Teflon™), or a copolymer or mixture of two or more thereof.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

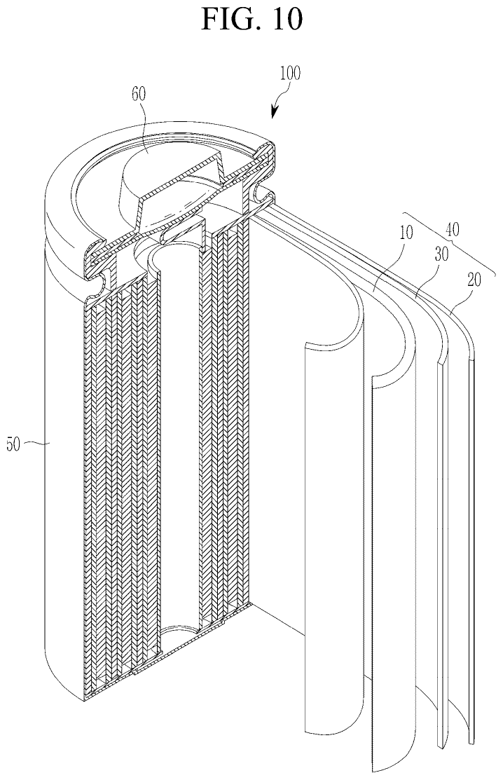

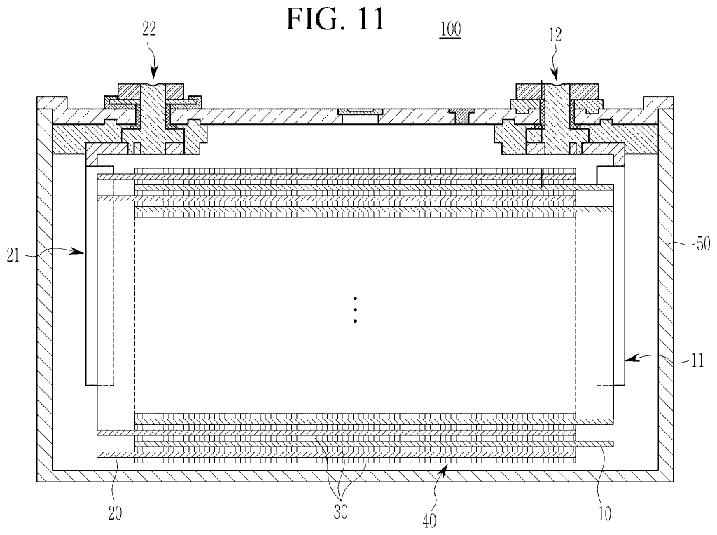

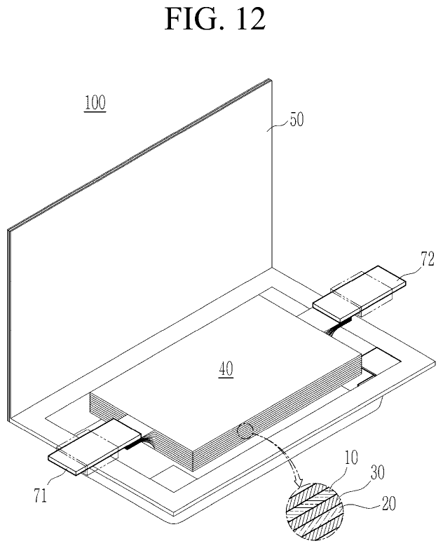

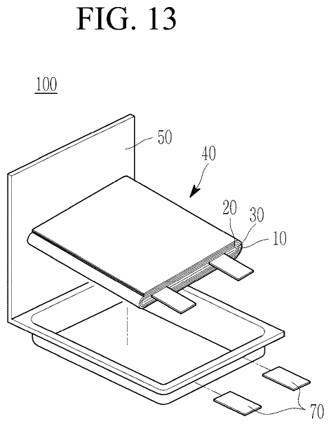

The rechargeable lithium battery may be classified into cylindrical, prismatic, pouch, coin, and the like, depending on the shape thereof. FIG. 10 to FIG. 13 are schematic views showing the rechargeable lithium batteries according to some example embodiments, where FIG. 10 is a cylindrical battery, FIG. 11 is a prismatic battery, and FIG. 12 and FIG. 13 are a pouch-shaped battery. Referring to FIG. 10 to FIG. 13, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte (not shown). The rechargeable lithium battery 100 may include a sealing member 60 that seals the case 50 as shown in FIG. 10. In FIG. 11, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 12 and FIG. 13, the rechargeable lithium battery 100 includes an electrode tab 70 illustrated in FIG. 13, or a positive electrode tab 71 and a negative electrode tab 72 illustrated in FIG. 12, the electrode tabs 70/71/72 forming an electric path for inducing the current formed in the electrode assembly 40 to the outside of the battery 100.

The rechargeable lithium battery according to some example embodiments may be applicable to, e.g., automobiles, mobile phones, and/or various types of electrical devices, but the present disclosure is not limited thereto.

Hereinafter, examples of the present disclosure and comparative examples are described. These examples, however, are not in any sense to be interpreted as limiting the scope of the disclosure.

### Example 1

### (1) Manufacturing of Positive Electrode

A positive electrode active material composition was prepared by mixing LiNi_{0.94}Co_{0.04}Al_{0.1}Mn_{0.01}O₂ as a positive electrode active material, polyvinylidene fluoride as a binder, and carbon nanotube as a conductive material in a weight ratio of 96:2:2 (=positive electrode active material:binder:conductive material). This composition was dispersed in an N-methyl pyrrolidone solvent to prepare a positive electrode active material slurry. The prepared positive electrode composition was coated on an aluminum foil current collector, and then dried and compressed to form a positive electrode active material layer with a thickness of 24 μm.

### Mesh Layer:

Subsequently, a mesh layer was disposed on the positive electrode active material layer. Herein, the mesh layer had a pore size of 30 μm, 5,000 holes per unit area (in²), and a thickness of 1.5 μm. The mesh skeleton was positioned in a grid encompassing an x-axis and a y-axis and composed of carbon nanotubes. The conductive material was composed of carbon nanotubes and coated onto the x-axis and y-axis directions of the mesh skeleton on both sides of the mesh skeleton. The mesh skeleton had a diameter of 1.4 μm, and the conductive material had a diameter of 0.008 μm.

### Positive Electrode:

On the mesh layer, the positive electrode active material slurry was coated again, and then dried and compressed to additionally form a positive electrode active material layer with a thickness of 24 μm. Through this, a positive electrode was formed to have a structure of active material layer-mesh layer-active material layer.

### (2) Manufacturing of Negative Electrode

A negative electrode composition was prepared by mixing 97.5 wt % of a graphite negative electrode active material, 1.5 wt % of carboxy methyl cellulose, and 1 wt % of styrene butadiene rubber in a water solvent. The negative electrode composition was coated on a copper foil current collector and then, dried and compressed to manufacture a negative electrode.

### (3) Manufacturing of Rechargeable Lithium Battery Cell

A polytetrafluoroethylene separator and an electrolyte solution prepared by dissolving 1 M LiPF₆ in a mixed solvent of ethylene carbonate and dimethyl carbonate in a volume ratio of 3:7 were used to manufacture a rechargeable lithium battery cell in a conventional method.

### Comparative Example 1

A rechargeable lithium battery cell was manufactured in the same manner as in Example 1 except that after first disposing a mesh layer on an aluminum foil current collector, the positive electrode active material slurry was coated thereon and then, dried and compressed to be 48 μm thick, thereby forming a structure of current collector-mesh layer-active material layer.

### Evaluation Example 1: Evaluation of Adhesive Strength

The positive electrodes according to the Example 1 and the Comparative Example 1 were measured with respect to adhesive strength. The adhesive strength was measured by using a tensile strength tester and attaching a corresponding positive electrode active material layer formed on the positive electrode current collector to a polyvinylchloride (PVC) double-sided adhesive tape and peeling each of the positive electrodes off to 180° at 10 mm/min, and the results are shown in Table 1 below.

TABLE 1

| | Positive electrode adhesive |
|---|---|
| | strength (gf/mm) |
| Example 1 | 1.7 |
| Comparative Example 1 | 0.9 |

Referring to Table 1 above, Example 1 was confirmed to exhibit improved adhesive strength, compared to Comparative Example 1. Comparative Example 1 having a structure of disposing a mesh layer on a positive electrode current collector was confirmed to exhibit deteriorated adhesive strength, compared to Example 1 having a structure of disposing the mesh layer between positive electrode active material layers. This confirmed that when the mesh layer was positioned between positive electrode active material layers, the adhesive strength between the active material layers was much improved.

### Evaluation Example 2: Evaluation of Electrical Resistance

The positive electrodes according to the Example 1 and the Comparative Example 1 were measured with respect to interface resistance between the electrode current collector and the positive electrode active material layer and the electrical resistance of the positive electrode active material layer, which is shown in Table 2 below. The electrical conductivity of the positive electrodes was calculated through a Van der Pauw method by using a multifunctional multimeter (Multimeter 2000/E, Keithley, USA).

TABLE 2

| | | Electrical resistance of the |
|---|---|---|
| | Interface resistance | positive electrode active |
| | (Ωcm) | material layer (Ωcm²) |
| Example 1 | 6.41 | 0.17 |
| Comparative | 11.28 | 0.50 |
| Example 1 | | |

Referring to Table 2 above, Example 1 was confirmed to exhibit all reduced interface resistance and electrical resistance of the positive electrode active material layer, compared to Comparative Example 1. Example 1 had a structure of disposing a mesh layer between positive electrode active material layers, which confirmed that the mesh skeleton included in the mesh layer and the conductive material coated on the mesh skeleton surface were confirmed to facilitate electron transfer, thereby improving electrical conductivity. As a result, the interface resistance and the electrical resistance of the positive electrode active material layer were reduced, thereby exhibiting much more desired or improved electrical characteristics.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

What is claimed is:

1. An electrode, comprising:
an electrode current collector;
an electrode active material layer on at least one surface of the electrode current collector; and
a mesh layer located in the electrode active material layer and spaced apart from the electrode current collector.

2. The electrode as claimed in claim 1, wherein:
the mesh layer comprises a mesh skeleton; and
the mesh skeleton comprises at least one of a metallic material, a carbon material, and a combination thereof.

3. The electrode as claimed in claim 2, wherein the metallic material comprises at least one of copper silver, iron, aluminum, and a combination thereof.

4. The electrode as claimed in claim 2, wherein the conductive material comprises at least one of graphene, carbon nanotube, graphite, carbon fiber, carbon black, and a combination thereof.

5. The electrode as claimed in claim 1, wherein a thickness of the electrode current collector is in a range of about 1% to about 10%, a thickness of the mesh layer is in a range of about 1% to about 8%, and a thickness of the electrode active material layer is in a range of about 82% to about 98%, based on 100% of a total thickness of the electrode.

6. The electrode as claimed in claim 1, wherein a pore size of the mesh layer is in a range of about 0.01 μm to about 100 μm.

7. The electrode as claimed in claim 1, wherein the number of holes per unit area (in²) of the mesh layer is in a range of about 10 to about 100,000.

8. The electrode as claimed in claim 1, wherein a diameter of the mesh skeleton is in a range of about 0.01 μm to about 100 μm.

9. The electrode as claimed in claim 1, wherein:
the mesh layer further comprises a conductive material; and
the conductive material is coated on the mesh skeleton.

10. The electrode as claimed in claim 9, wherein the conductive material comprises at least one of graphene, carbon nanotube, graphite, carbon fiber, carbon black, and a combination thereof.

11. The electrode as claimed in claim 9, wherein the conductive material comprises at least one of a spherical shape, an irregular shape, and a combination thereof.

12. The electrode as claimed in claim 9, wherein a diameter of the conductive material is in a range of about 0.005 μm to about 2 μm.

13. The electrode as claimed in claim 9, wherein the conductive material may be included in an amount in a range of about 0 wt % to about 50 wt % based on 100 wt % of the total mesh layer.

14. The electrode as claimed in claim 9, wherein the conductive material is aligned in at least one direction of the x-axis direction or the y-axis direction of the mesh skeleton.

15. The electrode as claimed in claim 9, wherein the conductive material is irregularly distributed and disposed on the mesh skeleton.

16. The electrode as claimed in claim 9, wherein the conductive material has a mixed arrangement of a shape aligned in at least one direction of the x-axis or y-axis direction of the mesh skeleton and a shape irregularly distributed.

17. The electrode as claimed in claim 1, wherein:
the electrode is a positive electrode, and
the electrode active material layer comprises a positive electrode active material, and the positive electrode active material comprises a lithium transition metal composite oxide.

18. The electrode as claimed in claim 1, wherein the lithium transition metal composite oxide comprises at least one of a lithium nickel-based composite oxide, a lithium cobalt-based composite oxide, a lithium manganese-based composite oxide, a lithium iron phosphate-based compound, a cobalt-free lithium nickel-manganese-based composite oxide, and a combination thereof.

19. The electrode as claimed in claim 1, wherein:
the electrode is a negative electrode,
the electrode active material layer comprises a negative electrode active material, and
the negative electrode active material comprises at least one of a carbon-based negative electrode active material, a silicon-based negative electrode active material, and a combination thereof.

20. A rechargeable lithium battery, comprising:
a positive electrode;
a negative electrode; and
an electrolyte,
wherein at least one of the positive electrode and the negative electrode comprises the electrode as claimed in claim 1.
